(19) United States
(12) Patent Application Publication
(10) Pub. No.: US 2016/0259197 A1
(43) Pub. Date: Sep. 8, 2016

(54) LIQUID CRYSTAL PANEL AND DISPLAY DEVICE

(71) Applicant: SHENZHEN CHINA STAR OPTOELECTRONICS TECHNOLOGY CO., LTD., Shenzhen, Guangdong (CN)

(72) Inventors: Shishuai HUANG, Shenzhen (CN); Shih Hsun LO, Shenzhen (CN)

(21) Appl. No.: 14/406,723

(22) PCT Filed: Jul. 3, 2014
(86) PCT No.: PCT/CN2014/081597

§ 371 Date: Dec. 16, 2014

(30) Foreign Application Priority Data
Jun. 9, 2014 (CN) 201410251941.2

(51) Int. Cl. G02F 1/1339; G02F 1/1362; G02F 1/1343; G02F 1/1368; G02F 1/1335; G02F 1/1333

(52) U.S. Cl. CPC G02F 1/13394; G02F 1/133514; G02F 1/133345; G02F 1/134309; G02F 1/13439; G02F 1/1368; G02F 1/136286; G02F 1/136227; G02F 2001/13398

(57) ABSTRACT

The present disclosure discloses a liquid crystal display panel, a display device and a method for driving the display device. The liquid crystal display panel comprises a number of scan lines, data lines, and sub pixel unit arrays, wherein a first sub pixel group and a second sub pixel group are alternately arranged between the n^{th} scan line and (n+1)^{th} scan line. The first sub pixel group is connected to the n^{th} scan line and the second sub pixel group is connected to the (n+1)^{th} scan line, so that the sub pixel units controlled by the same scan line are distributed in adjacent rows, n being positive integer.

### CROSS-REFERENCE TO RELATED APPLICATIONS

The present disclosure claims priority for Chinese patent application CN 201410241110.7 entitled “liquid crystal panel, display device and a method for driving the display device” and filed on May 30, 2014, which is incorporated herein by reference.

### TECHNICAL FIELD

The present disclosure relates to the technical field of display. Specifically, it relates to a liquid crystal display panel, a display device and a method for driving the display device.

### TECHNICAL BACKGROUND

TFT-LCD crosstalk refers to a displaying abnormality caused by the mutual effect between different areas of the display panel. Based on the position influenced by the crosstalk, TFT-LCD crosstalk phenomena can be divided into vertical-crosstalk and horizontal-crosstalk, wherein horizontal crosstalk (H-crosstalk) is the most common and also the worst one.

H-crosstalk is usually detected by using a test screen consisting of “a dark background and a bright frame” as shown in FIG. 1. The bright frame with high gray scale is displayed in a central area 105, and the dark background with low gray scale is displayed in the surrounding areas 101 to 104, as shown in FIG. 1. In this case, the driving voltages of the data lines within areas 102, 104 and 105 experience instantaneous voltage jumps at the boundaries of edges of the above three areas contacting with each other. For example, in area 102, the driving voltages of the data lines are in low level state so as to display the dark background; and in area 105, the driving voltages of the data lines are in high level state so as to display the bright frame. Thus, voltage jumps from low level to high level occur to the driving voltages of the data lines at the boundary between area 102 and area 105.

Because of the parasitic capacitance existing between the data line and the COM line, when the driving voltage of a data line sharply changes in an instant, voltage V_{com} of the common electrode will be varied toward the same direction as the change of the driving voltage, which takes a certain time to return to normal. As a result, the pixel voltage at the boundary between area 102 and area 105 in FIG. 1 cannot reach the specified voltage value, forming a sharp bright line 106.

Similarly, a sharp bright line 107 is formed at the boundary between area 104 and area 105 in FIG. 1. The appearance of sharp lines 106 and 107 means a H-crosstalk phenomenon.

Therefore, a liquid crystal display panel, a display device and a method for driving the display device which can eliminate H-crosstalk are needed in the field.

### SUMMARY OF THE INVENTION

To solve the above technical problem, the present disclosure provides a liquid crystal display panel which can eliminate H-crosstalk. The liquid crystal display panel comprises a number of scan lines, data lines and sub pixel unit arrays, wherein a first sub pixel group and a second sub pixel group are alternately arranged between the n^{th} scan line and (n+1)^{th} scan line. The first sub pixel group is connected to the n^{th} scan line and the second sub pixel group is connected to the (n+1)^{th} scan line, so that the sub pixel units controlled by the same scan line are distributed in adjacent rows, n being positive integer.

According to an embodiment of the present disclosure, the first sub pixel group and the second pixel group respectively comprise 2m sub pixel units arranged side by side, m being positive integer.

According to an embodiment of the present disclosure, m is in a range of 1≦m≦50.

According to an embodiment of the present disclosure, the data signals provided by adjacent data lines have opposite polarities within the same scanning period.

According to an embodiment of the present disclosure, the data signals provided by the same data line have the same polarity within the same frame period.

According to another aspect of the present disclosure, a liquid crystal display device is provided, comprising:

the abovementioned liquid crystal display panel,

a scanning signal driver unit for providing a sequence of scanning pulse signals to the scan lines so as to turn on the sub pixel units connected thereto respectively, and

a data signal driver unit for providing data signals to the data lines so as to charge the sub pixel units connected to the data lines when the sub pixel units connected to the scan lines are turned on.

According to an embodiment of the present disclosure, the device further comprises a timing controller for providing a polarity reversal signal to the data signal driver unit, so that the data signals provided by adjacent data lines have opposite polarities within the same line period and the data signals provided by the same data line have the same polarity within the same frame period.

According to another aspect of the present disclosure, a method for driving a liquid crystal display device is provided, comprising the steps:

providing a sequence of scanning pulse signals to the scan lines so as to turn on the sub pixel units connected thereto respectively, wherein a first sub pixel group and a second sub pixel group are alternately arranged between the n^{th} scan line and (n+1)^{th} scan line, and the first sub pixel group is connected to the n^{th} scan line and the second sub pixel group is connected to the (n+1)^{th} scan line, so that the sub pixel units controlled by the same scan line are distributed in adjacent rows,

providing data signals to the data lines so as to charge the sub pixel units connected to the data lines when the sub pixel units connected to the scan lines are turned on,

wherein in the n^{th} line period, the scan line turns on the first sub pixel group among the sub pixel units in the n^{th} line, so that the data line can charge the first sub pixel group, and

in the (n+1)^{th} line period, the scan line turns on the second sub pixel group among the sub pixel units in the n^{th} line, so that the data line can charge the second sub pixel group.

According to an embodiment of the present disclosure, the data signals provided by adjacent data lines have opposite polarities within the same scanning period and the data signals provided by the same data line have the same polarity within the same frame period.

According to an embodiment of the present disclosure, the first sub pixel group and the second pixel group respectively comprise 2m sub pixel units arranged side by side, m being positive integer in a range of 1≦m≦50.

According to the present disclosure, 2n (n=1˜50) sub pixel units horizontally adjacent to each other are arranged as one group. The sub pixel units in each group are alternately distributed above and below the scan line that controls them, with the sub pixel units controlled by the same scan line distributed in adjacent rows. When the display image turns from black to white or from white to black in one scanning period, not all of the data signal voltages provided by the data lines experience voltage jump, but only half of the data signal voltages do. Thus, the average voltage change of the data lines in each scanning period drops by half, causing the change of the V_{com} voltage to drop by half, thereby significantly lowering the brightness of the gray line. In the meantime, over sharp change of the brightness can be avoided and the gray line can become obscure, thereby eliminating the H-crosstalk phenomenon.

Other features and advantages of the present disclosure will be further explained in the following description and partially become obvious therefrom, or be understood through the embodiments of the present disclosure. The objectives and advantages of the present disclosure will be achieved through the structure specifically pointed out in the description, claims, and the accompanying drawings.

### BRIEF DESCRIPTION OF THE DRAWINGS

The accompanying drawings, which constitute a part of the description, are used to further explain the present disclosure in combination with the embodiments. It should be understood that the drawings are only provided to better understand the present disclosure, they should not be construed as limitations thereto. In the drawings:

FIG. 1 shows a screen consisting of dark background and bright frame for detecting H-crosstalk phenomenon;

FIG. 2 schematically shows a structure of a liquid crystal display device according to an embodiment of the present disclosure;

FIG. 3 schematically shows the structure of a display panel in the prior art;

FIG. 4 shows a voltage distribution of the data lines of the display panel when the test image as shown in FIG. 1 is displayed in the prior art;

FIG. 5a schematically shows the driving voltages of data lines D5, D7, D9, and D11 when the test image as shown in FIG. 1 is displayed in the prior art;

FIG. 5b schematically shows the driving voltages of data lines D6, D8, D10, and D12 when the test image as shown in FIG. 1 is displayed in the prior art;

FIG. 5c schematically shows the voltage of a common electrode when the test image as shown in FIG. 1 is displayed in the prior art;

FIG. 6 schematically shows the structure of a display panel according to an embodiment of the present disclosure;

FIG. 7 shows a voltage distribution of the data lines when the test image as shown in FIG. 1 is displayed on the display panel as shown in FIG. 6;

FIG. 8a schematically shows the driving voltages on data lines D7 and D11 when the test image as shown in FIG. 1 is displayed on the display panel as shown in FIG. 6;

FIG. 8b schematically shows the driving voltages on data lines D5 and D9 when the test image as shown in FIG. 1 is displayed on the display panel as shown in FIG. 6;

FIG. 8c schematically shows the driving voltages on data lines D8 and D12 when the test image as shown in FIG. 1 is displayed on the display panel as shown in FIG. 6;

FIG. 8d schematically shows the driving voltages on data lines D6 and D10 when the test image as shown in FIG. 1 is displayed on the display panel as shown in FIG. 6;

FIG. 8e schematically shows a voltage on the common electrode when the test image as shown in FIG. 1 is displayed on the display panel as shown in FIG. 6;

FIG. 9a shows a distribution of the average brightness of the sub pixel units from columns 1 to 4 when the test image as shown in FIG. 1 is displayed in the prior art;

FIG. 9b shows a distribution of the average brightness of the sub pixel units from columns 1 to 4 when the test image as shown in FIG. 1 is displayed on the display panel as shown in FIG. 6.

### DETAILED DESCRIPTION OF THE EMBODIMENTS

In order to clarify the objective, technical solutions, and the advantages of the present disclosure, the present disclosure will be further explained with reference to the accompanying drawings.

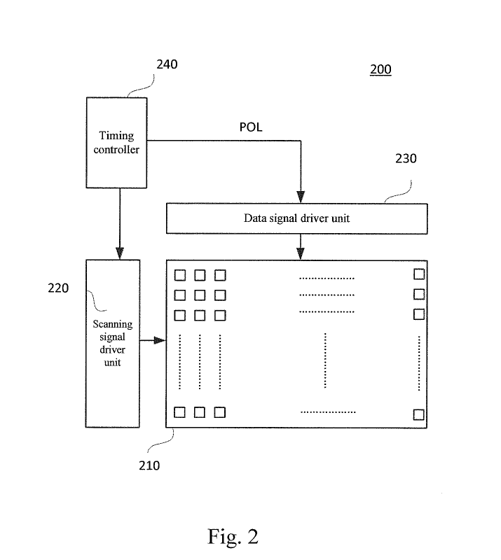

FIG. 2 schematically shows the structure of a liquid crystal display device 200 according to an embodiment of the present disclosure. As shown in FIG. 2, the liquid crystal display device 200 comprises a display panel 210, a scanning signal driver unit 220, a data signal driver unit 230, and a timing controller 240.

The scanning signal driver unit 220 and the data signal driver unit 230 are electrically connected to the display panel 210. The timing controller 240 is electrically connected to both the scanning signal driver unit 220 and the data signal driver unit 230, so as to control the scanning signal driver unit 220 to scan the display panel 210, and control the data signal driver unit 230 to drive the display panel 210 to display images.

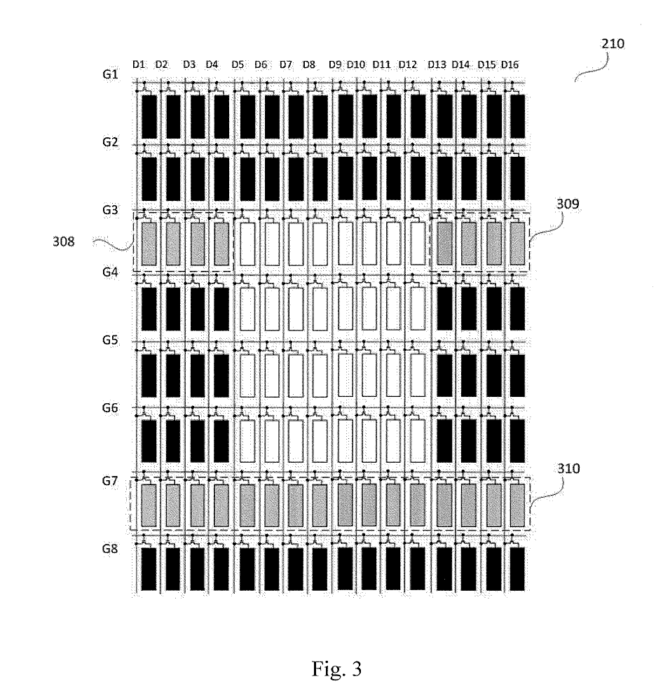

FIG. 3 schematically shows the structure of the display panel 210 in the prior art. The display panel 210 comprises a number of scan lines G1 to G8 and data lines D1 to D16 arranged in a staggered manner, as well as sub pixel unit arrays. The n^{th} scan line controls the on-off state of sub pixel units in the n^{th} row, i.e., the sub pixel units to be controlled are located at the same side of the scan line which controls them.

The timing controller 240 provides a polarity reversal signal POL, so that the data signal voltage of each of the odd numbered data lines D1, D3, D5, D7, . . . , has positive polarity, namely, V_{data} is greater than or equals to V_{com} (voltage on the common electrode); and the data signal voltage of each of the even numbered data lines D2, D4, D6, D8, . . . , has negative polarity, namely, V_{data} is smaller than or equals to V_{com} (voltage on the common electrode). The POL signal further leads to identical polarity for the data signals provided by the same data line in the same frame period.

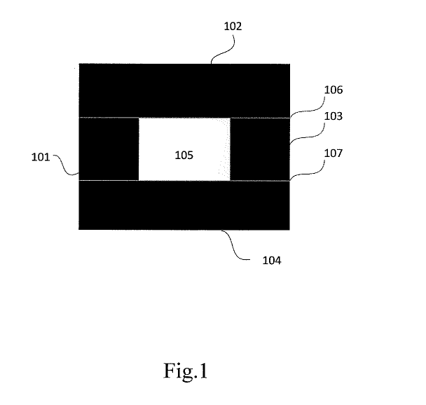

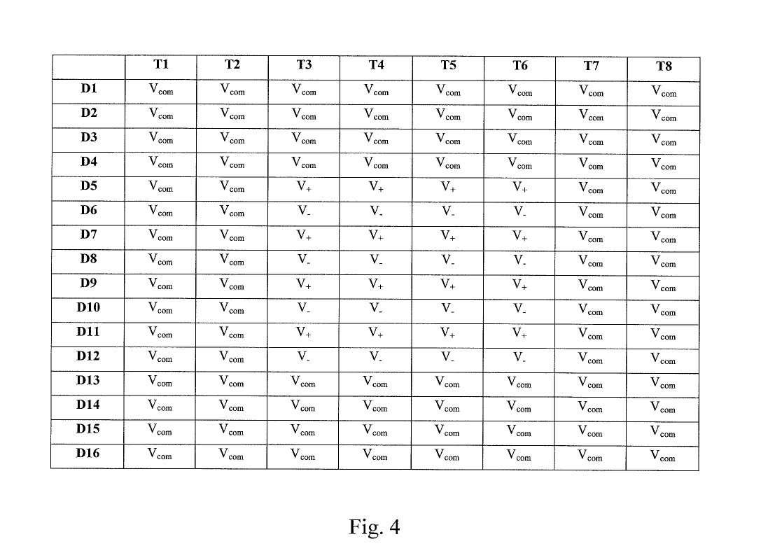

When the test image consisting of dark background and bright frame according to FIG. 1 is displayed, the area controlled by scan lines G3 to G6 and data lines D5 to D12 shows a white area, and the rest area shows a black background. In this case, the voltage distribution of the data signals provided by the data lines in FIG. 3 in each scanning period is as shown in FIG. 4.

In the following, the causes of H-crosstalk in the prior art will be expounded in combination with FIGS. 3 and 4.

(1) During scanning periods T1 and T2, scan lines G1 and G2 are switched on; and all the sub pixel units in row 1 and row 2 appear black. At this time, none of the voltages of data lines D1 to D16 changes (V_{data}=V_{com}), and all the sub pixel units in row 1 and row 2 can normally appear black.

(2) Upon the arrival of scan period T3, scan line G3 is turned on. Under normal circumstances, the sub pixel units in row 3, from columns 1 to 4 and from columns 13 to 16 should appear black, and those from column 5 to column 12 should appear white. However, due to the positive polarity thereof, the data signal voltage V_{data} of each of data lines D5, D7, D9, and D11 instantly rises from the previous V_{data}=V_{com} to V_{data}=V₊. Similarly, due to the negative polarity thereof, the data signal voltage of each of data lines D6, D8, D10, and D12 drops from the previous V_{data}=V_{com} to V_{data}=V₋.

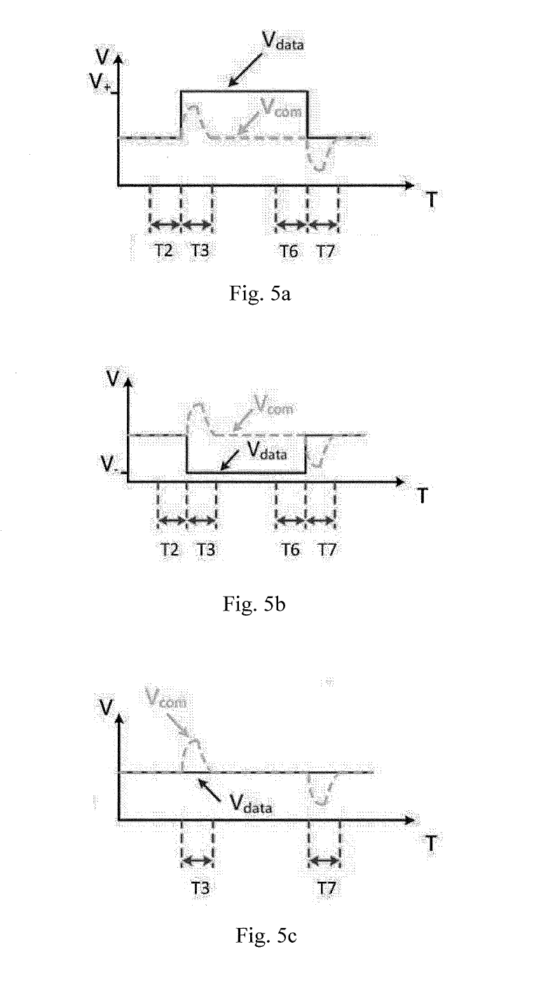

Because V₊-V_{com} >V_{com}-V₋, the average data signal voltage of data lines D5 to D12 instantly increases. Due to the parasitic capacitance existing between the data line and the COM line, the voltage V_{com} of the common electrode is pulled up and instantly increases, which sustains for a certain time period, as shown by the dash line in FIG. 5a.

At this moment, the data signal voltage V_{data} written into the sub pixel units from columns 1 to 4 and from columns 13 to 16 on both sides of row 3 equals to the normal V_{com}, but the actual V_{com} voltage is higher than the normal V_{com} voltage. The dash line to which T3 in FIG. 5c corresponds represents the actual V_{com} voltage. Thus, bias voltages are exerted on the abovementioned sub pixel units, causing the display of gray images in areas 308 and 309 in FIG. 3, instead of the normal black image.

(3) During the scanning periods T4, T5, and T6, scan lines G4, G5, and G6 are successively turned on. The sub pixel units from columns 1 to 4 and from columns 13 to 16 should appear black, and the sub pixel units from columns 5 to 12 should appear white. At this point, no change occurs to the data signal voltages of data lines D1 to D16, and all the sub pixel units can normally display black and white.

(4) Upon the arrival of scanning period T7, scan line G7 is turned on. Under normal circumstances, all the sub pixel units in row 7 should appear black.

However, due to the positive polarity thereof, the data signal voltage of each of data lines D5, D7, D9, and D11 instantly decreases from the previous V_{data}=V₊ to V_{data}=V_{com}. Similarly, due to the negative polarity thereof, the data signal voltage of each of data lines D6, D8, D10, and D12 instantly increases from the previous V_{data}=V₋ to V_{data}=V_{com}. Because V₊-V_{com} >V_{com}-V₋, the average voltage of data lines D5 to D12 instantly decreases. Consequently, V_{com} is pulled down and instantly decreases. It takes a certain time period for V_{com} to return to normal, as shown by the dash line to which T7 corresponds in FIG. 5b.

At this moment, the data signal voltage V_{data} written into the sub pixel units from columns 1 to 16 in row 7 equals to the normal V_{com}, but the actual V_{com} voltage is lower than the normal V_{com} voltage, with the actual V_{com} voltage being indicated by the dash line to which T7 corresponds in FIG. 5c. Thus, bias voltages are exerted on the abovementioned sub pixel units, causing the display of gray image in area 310 in FIG. 3 instead of normal black image.

(5) During scanning period T8, scan line G8 is switched on, and all the sub pixel units in row 8 appear black. At this time, none of the voltages of data lines D1 to D16 changes (i.e., V_{data}=V_{com}), and all the sub pixel units in row 8 can normally display black.

In order to overcome the displaying abnormality in areas 308, 309, and 310, a display panel 210 as shown in FIG. 6 is provided according to an embodiment of the present disclosure.

FIG. 6 schematically shows the structure of a display panel 210 according to an embodiment of the present disclosure. The display panel 210 comprises a number of scan lines G1 to G8 and data lines D1 to D16 arranged in a staggered manner, and sub pixel unit arrays, wherein the sub pixel units controlled by the same scan line are distributed in adjacent rows.

For example, among the sub pixel unit arrays, the sub pixel units in row 3 comprise a first sub pixel unit group and a second sub pixel unit group alternately arranged, wherein the first sub pixel unit group comprises sub pixel units P37 and P38 connected to scan line G3, and the second sub pixel unit group comprises sub pixel units P35 and P36 connected to scan line G4.

Hence, sub pixel units P25 and P26 controlled by scan line G3 are distributed in row 2. And sub pixel units P37 and P38 controlled by scan line G3 are distributed in row 3.

It should be noted that although a sub pixel unit group according to this embodiment comprises two sub pixel units arranged side by side, it would be easy for one skilled in the art to understand that a sub pixel unit group can also comprise 4, 6, . . . , to 2m sub pixel units, wherein the number of sub pixel units in one sub pixel unit group is usually no more than 100, i.e. m=1˜50.

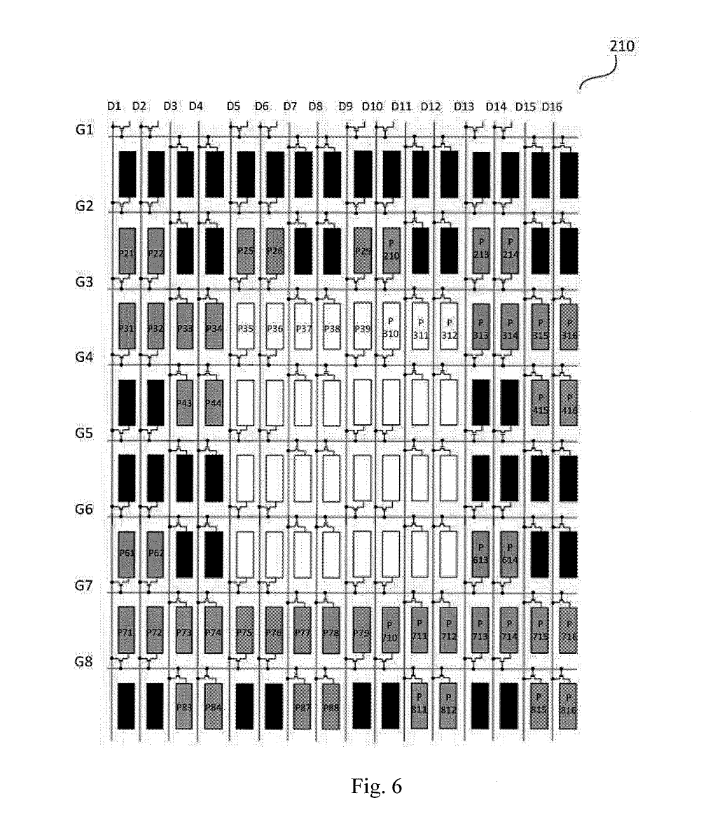

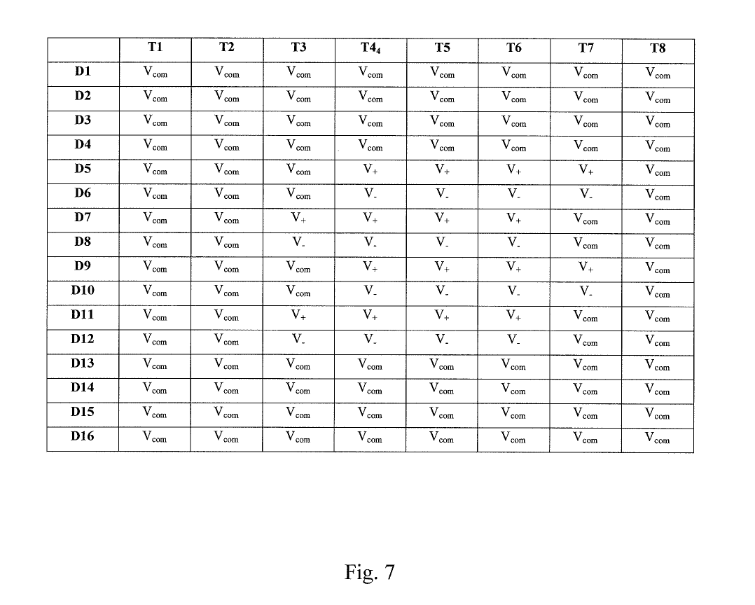

When the test image consisting of a dark background and a bright frame as shown in FIG. 1 is displayed, the area controlled by scan lines G3 to G6 and data lines D5 to D12 appears white, and the rest area appears black. At this moment, the voltage distribution of the data signals provided by the data lines in FIG. 6 during each scanning period is as shown in FIG. 7.

The principles of eliminating H-crosstalk according to the embodiment of the present disclosure will be further explained with reference to the accompanying drawings FIGS. 6 and 7.

(1) During scanning periods T1 and T2, scan lines G1 and G2 are switched on and all the sub pixel units in row 1 and row 2 appear black. At this time, none of the voltages of data lines D1 to D16 changes (i.e., V_{data}=V_{com}), and all the sub pixel units in row 2 and row 3 can normally display black.

(2) Upon the arrival of scanning period T3, scan line G3 is turned on. Under normal circumstances, the sub pixel units from columns 1 to 6 and those from columns 9 to 10 and those from columns 13 to 16 should appear black, and the sub pixel units in columns 7, 8, 11, and 12 should appear white.

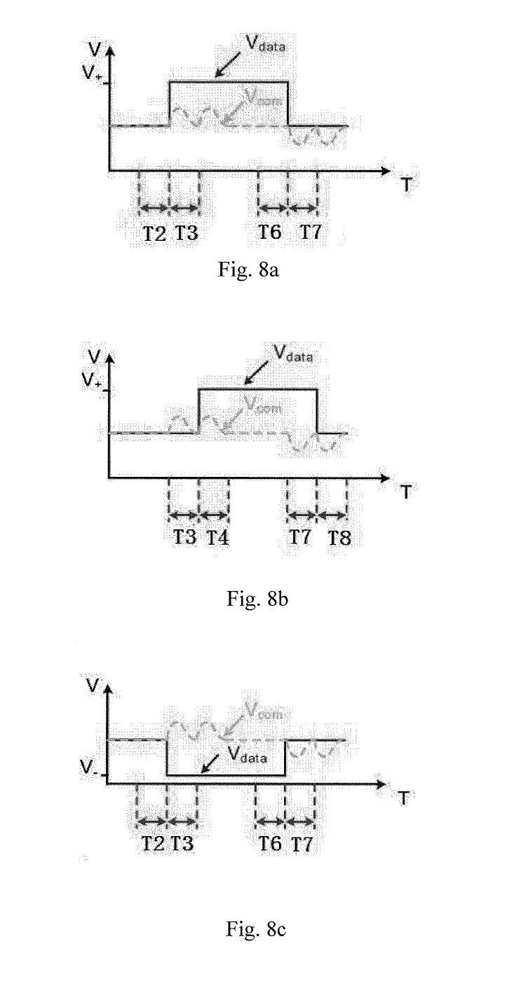

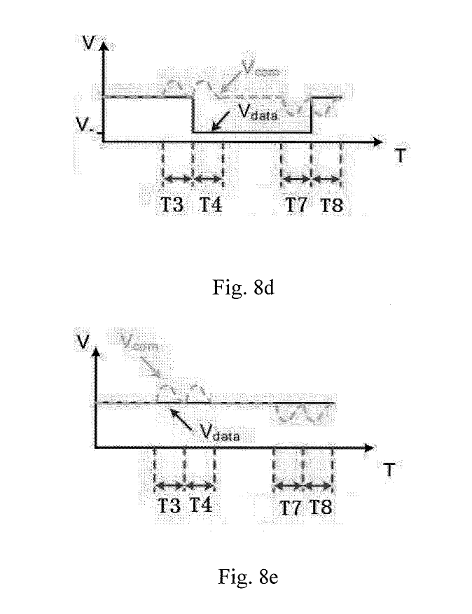

As shown in FIG. 8a, due to the positive polarity thereof, the data signal voltage of each of data lines D7 and D11 increases from the previous V_{data}=V_{com} to V_{data}=V₊, and the voltage V_{data} of each of data lines D5 and D9 remains to be V_{data}=V_{com}. As shown in FIG. 8c, due to the negative polarity thereof, the data signal voltage of each of data lines D8 and D12 drops from the previous V_{data}=V_{com} to V_{data}=V₋, and the voltage V_{data} of each of data lines D6 and D10 remains to be V_{data}=V_{com}. Because V₊-V_{com} >V_{com}-V₋, the average voltage of data lines D7, D8, D11, and D12 instantly increases. Consequently, V_{com} is pulled up and instantly increases as well, which takes a certain time to return to normal.

According to FIG. 5a, in the prior art, the average voltage of eight data lines (D5-D12) instantly increases. However, in an embodiment according to the present disclosure, the average voltage of only four data lines instantly increases, resulting in an increment of the average voltage only half of that in the prior art. Therefore, the instant increase of V. voltage is only half of that in the prior art.

At this moment, the data signal voltage V_{data} written into the sub pixel units from columns 1 to 6, those from columns 9 to 10, and those from columns 13 to 16 equals to the normal V_{com}, but the actual V_{com} is higher than the normal V_{com}. Therefore, bias voltages are exerted on the abovementioned sub pixel units, resulting in the display of gray image in sub pixel units P21, P22, P33, P34, P25, P26, P29, P210, P213, P214, P315, and P316. However, because the increment of the V_{com} voltage is only half of that in the prior art, the bias voltages exerted on these sub pixel units are far less than those in the prior art, thereby significantly decreasing the brightness of the gray image.

(3) Upon the arrival of scanning period T4, scan line G4 is turned on. Under normal circumstances, sub pixel units from columns 1 to 4 and those from columns 13 to 16 should appear black, and sub pixels from columns 5 to 12 should appear white.

Referring to FIGS. 8a and 8b, in the center region, due to the positive polarity thereof, the data signal voltage V_{data} of each of D5 and D9 increases from the previous V_{data}=V_{com} to V_{data}=V₊, and the voltage V_{data} of each of data lines D7 and D11 remains to be V_{data}=V₊. As shown in FIGS. 8c and 8d, due to the negative polarity thereof, the data signal voltage V_{data} of each of D6 and D10 instantly decreases from the previous V_{data}=V_{com} to V_{data}=V₋, and the voltage V_{data} of each of data lines D8 and D12 remains to be V_{data}=V₃₁. Because V₊-V_{com} >V_{com}-V₋, the average voltage of data lines D5, D6, D9, and D10 instantly increases, causing V_{com} to be pulled up and instantly increases, which takes a certain time period to return to normal. In this case, the average voltage increase of the data lines is the same as that when the scan line G3 is turned on. Thus, the voltage increase of V_{com} when being pulled up is also the same as that when the scan line G3 is turned on, as indicated by the dash line at T4 in FIG. 8e.

At this moment, the data signal voltage V_{data} written into the sub pixel units from columns 1 to 4 and those from columns 13 to 16 equals to the normal V_{com}, but the actual V_{com} voltage is higher than the normal V_{com}. Thus, bias voltages are exerted on the abovementioned sub pixel units, resulting in the display of gray image in sub pixel units P31, P32, P43, P44, P313, P314, P415, and P416. Since the instant increase of the V_{com} voltage is the same as that when the scan line G3 is turned on, the bias voltages exerted on these sub pixel units are also the same as those when the scan line G3 is turned on, resulting in the same brightness of the gray image.

(4) During scanning periods T5 and T6, scan lines G5 and G6 are switched on. The sub pixel units from columns 1 to 4 and those from columns 13 to 16 should appear black, and the sub pixel units from columns 5 to 12 should appear white. At this time, none of the voltages of data lines D1 to D16 changes, and all the sub pixel units can normally display black or white.

(5) Upon the arrival of scanning period T7, scan line G7 is turned on. Under normal circumstances, the sub pixel units from columns 1 to 4, those from columns 7 to 8, and those from columns 11 to 16 should appear black, and the sub pixel units in columns 5, 6, 9, and 10 should appear white.

As shown in FIGS. 8a and 8b, due to the positive polarity thereof, the data signal voltage V_{data} of each of data lines D7 and D11 instantly drops from the previous V_{data}=V₊ to V_{data}=V_{com}, and the voltage of each of data lines D5 and D9 remains to be V_{data}=V₊. As shown in FIGS. 8c and 8d, due to the negative polarity thereof, the data signal voltage V_{data} of each of D8 and D12 instantly increase from the previous V_{data}=V₋ to V_{data}=V_{com}, and the voltage of each of data lines D6 and D10 remains to be V_{data}=V₋. Because V₊-V_{com} >V_{com}-V₋, the average voltage of data lines D7, D8, D11, and D12 instantly decreases, pulling the V_{com} down. The drop of V_{com} takes a certain time to return to normal, as indicated by the dash line at T7 in FIG. 8e.

In the prior art, the average voltage of eight data lines (D5-D12) instantly decreases. However, in this embodiment, the average voltage of only four data lines instantly decreases, resulting in an average voltage drop value only half of that in the prior art. Therefore, the instant decrease of V_{com} voltage is only half of that in the prior art.

At this moment, the data signal voltage V_{data} written into the sub pixel units from columns 1 to 4, those from columns 7 to 8, and those from columns 11 to 16 equals to the normal V_{com}, but the actual V_{com} voltage is lower than the normal V_{com}. Thus, bias voltages are exerted on the abovementioned sub pixel units, resulting in the display of gray image in sub pixel units P61, P62, P73, P74, P77, P78, P711, P712, P613, P614, P715, and P716. However, because the instant drop of the V_{com} voltage is only half of that in the prior art, the bias voltages exerted on these sub pixel units are far less than those in the prior art, thereby significantly decreasing the brightness of the gray image.

(6) Upon the arrival of scanning period T8, scan line G8 is turned on. Under normal circumstances, all the sub pixel units in row 8 appear black.

As shown in FIGS. 8a and 8b, due to the positive polarity thereof, the data signal voltage V_{data} of each of data lines D5 and D9 drops from the previous V_{data}=V₊ to V_{data}=V_{com}, and the voltage V_{data} of each of data lines D7 and D11 remains to be V_{data}=V_{com}. As shown in FIGS. 8c and 8d, due to the negative polarity thereof, the data signal voltage V_{data} of each of D6 and D10 increases from the previous V_{data}=V₃₁ to V_{data}=V_{com}, and the voltage V_{data} of each of data lines D8 and D12 remains to be V_{data}=V_{com}. Because V₊-V_{com} >V_{com}-V₋, the average voltage of data lines D5, D6, D9, and D10 instantly decreases, pulling the V_{com} down. The drop of V_{com} takes a certain time to return to normal, as indicated by the dash line at T8 in FIG. 8e. The average voltage drop of the data lines is the same as that when T7 begins, resulting in the same decrease of V_{com} voltage as that when T7 begins.

At this moment, the data signal voltage V_{data} written into the sub pixel units in row 8 from columns 1 to 16 equals to the normal V_{com}, but the actual V_{com} voltage is lower than the normal V_{com}. Thus bias voltages are exerted on the abovementioned sub pixel units, resulting in the display of gray image in sub pixel units P71, P72, P83, P84, P75, P76, P87, P88, P79, P710, P811, P812, P713, P714, P815 and P816. Since the instant decrease of V_{com} voltage is the same as that when scan line G7 is turned on, the bias voltages exerted on these sub pixel units are also the same as those when scan line G7 is turned on, resulting in the same brightness of the gray image.

(7) During scanning period T9, scan line G9 is turned on, and all the pixel units from columns 1 to 16 should appear black. None of the voltages of data lines D1 to D16 changes (i.e., V_{data}=V_{com}) and all the sub pixel units appear black.

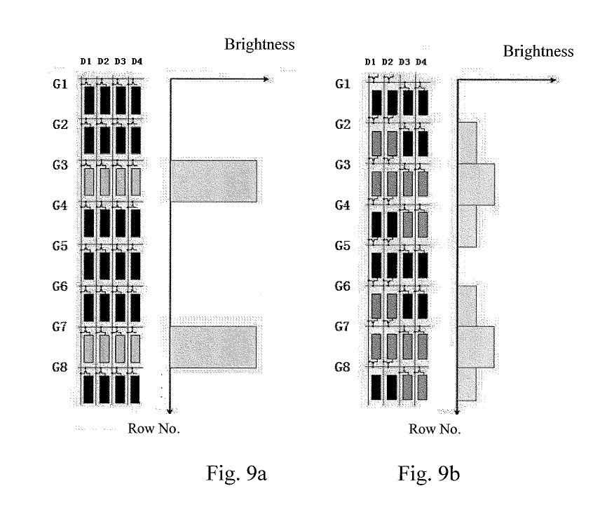

In conclusion, in the display panel according to the present disclosure, the sub pixel units connected to the same scan line are distributed in adjacent rows. When the image turns from black to white or from white to black, not all data signal voltages provided by the data lines experience voltage jump within the same scanning period, but rather only half of the data signal voltages do. Therefore, the average voltage change of the data lines in each scanning period drops by half, causing the change of the V_{com} voltage to drop by half, thereby significantly lowering the brightness of the gray line, as shown in FIGS. 9a and 9b.

Furthermore, because the sub pixel units connected to the same scan line are distributed in adjacent rows, when the V_{com} voltage changes, the sub pixel units that change in brightness are also located in adjacent rows. Consequently, one gray line will be expanded to three gray lines as shown in FIG. 9b. Because all the sub pixels in row 3, columns 1 to 4 appear gray, this gray line in the middle has the highest brightness. And because only half of the sub pixels in row 2 and row 4, columns 1 to 4 appear gray, the brightness of the first gray line and that of the third gray line are only half of that of the gray line in the middle. Thus, the overly sharp change of brightness of the gray line can be avoided, and the gray line can become obscure.

According to the present disclosure, a structure of the display panel as shown in FIG. 6 is adopted, in which the sub pixel units are divided into groups, each group comprising 2n (n=1-50) sub pixel units adjacent to each other. The sub pixel units in each group are alternately distributed above and below the scan line which controls them, such that reduction of brightness and obscurity of the gray line generated by H-crosstalk can be achieved, thereby eliminating the H-crosstalk phenomenon.

It should be noted that although in the present embodiment a test image consisting of black background and white frame is used to describe the principle of eliminating H-crosstalk, it would be easy for one skilled in the art to understand that the principle and effect of the present disclosure also apply to all kinds of test images containing dark background and bright frame.

The above embodiment is adopted only for better understanding the present disclosure instead of limitations thereto. Any one skilled in the art can make various modifications to the implementing forms and details of the present disclosure without departing from the scope and spirit of the present disclosure. It should be note that the scope of the present disclosure should still be subjected to that defined in the claims.

1. A liquid crystal display panel, comprising a number of scan lines, data lines, and sub pixel unit arrays, wherein
a first sub pixel group and a second sub pixel group are alternately arranged between the n^{th} scan line and (n+1)^{th} scan line, and
the first sub pixel group is connected to the n^{th} scan line and the second sub pixel group is connected to the (n+1)^{th} scan line, so that the sub pixel units controlled by the same scan line are distributed in adjacent rows, n being positive integer.

2. The liquid crystal display panel according to claim 1, wherein the first sub pixel group and the second pixel group respectively comprise 2m sub pixel units arranged side by side, m being positive integer.

3. The liquid crystal display panel according to claim 2, wherein m is in a range of 1≦m≦50.

4. The liquid crystal display panel according to claim 1, wherein the data signals provided by adjacent data lines have opposite polarities within the same scanning period.

5. The liquid crystal display panel according to claim 4, wherein the data signals provided by the same data line have the same polarity within the same frame period.

6. A liquid crystal display device comprising:
a liquid crystal display panel having a number of scan lines, data lines, and sub pixel unit arrays, wherein a first sub pixel group and a second sub pixel group are alternately arranged between the n^{th} scan line and (n+1)^{th} scan line, and the first sub pixel group is connected to the n^{th} scan line and the second sub pixel group is connected to the (n+1)^{th} scan line, so that the sub pixel units controlled by the same scan line are distributed in adjacent rows, n being positive integer,
a scanning signal driver unit for providing a sequence of scanning pulse signals to the scan lines so as to turn on the sub pixel units connected thereto, and
a data signal driver unit for providing data signals to the data lines so as to charge the sub pixel units connected to the data lines when the sub pixel units connected to the scan lines are turned on.

7. The liquid crystal display device according to claim 6, wherein the device further comprises a timing controller for providing a polarity reversal signal to the data signal driver unit, so that the data signals provided by adjacent data lines have opposite polarities within the same line period, and the data signals provided by the same data line have the same polarity within the same frame period.

8. The liquid crystal display device according to claim 6, wherein the first sub pixel group and the second pixel group respectively comprise 2m sub pixel units arranged side by side, m being positive integer.

9. The liquid crystal display device according to claim 8, wherein the device further comprises a timing controller for providing a polarity reversal signal to the data line driver unit, so that the data signals provided by adjacent data lines have opposite polarities within the same line period and the data signals provided by the same data line have the same polarity within the same frame period.

10. The liquid crystal display device according to claim 8, wherein m is in a range of 1≦m≦50.

11. The liquid crystal display device according to claim 10, wherein the device further comprises a timing controller for providing a polarity reversal signal to the data line driver unit, so that the data signals provided by adjacent data lines have opposite polarities within the same line period and the data signals provided by the same data line have the same polarity within the same frame period.

12. The liquid crystal display device according to claim 6, wherein the data signals provided by adjacent data lines have opposite polarities within the same scanning period.

13. The liquid crystal display device according to claim 12, wherein the device further comprises a timing controller for providing a polarity reversal signal to the data line driver unit, so that the data signals provided by adjacent data lines have opposite polarities within the same line period and the data signals provided by the same data line have the same polarity within the same frame period.

14. The liquid crystal display device according to claim 12, wherein the data signals provided by the same data line have the same polarity within the same frame period.

15. The liquid crystal display device according to claim 14 wherein the device further comprises a timing controller for providing a polarity reversal signal to the data line driver unit, so that the data signals provided by adjacent data lines have opposite polarities within the same line period and the data signals provided by the same data line have the same polarity within the same frame period.

16. A method for driving a liquid crystal display device, comprising the steps of:
providing a sequence of scanning pulse signal to the scan lines so as to respectively turn on the sub pixel units connected to the scan lines, wherein a first sub pixel group and a second sub pixel group are alternately arranged between the n^{th} scan line and (n+1)^{th} scan line, and the first sub pixel group is connected to the n^{th} scan line and the second sub pixel group is connected to the (n+1)^{th} scan line, so that the sub pixel units controlled by the same scan line are distributed in adjacent rows,
providing data signals to the data lines so as to charge the sub pixel units connected to the data lines when the sub pixel units connected to the scan lines are turned on,
wherein in the n^{th} line period, the scan line turns on the first sub pixel group among the sub pixel units in the n^{th} line, so that the data line can charge the first sub pixel group, and
in the (n+1)^{th} line period, the scan line turns on the second sub pixel group among the sub pixel units in the n^{th} line, so that the data line can charge the second sub pixel group.

17. The method according to claim 16, wherein the data signals provided by adjacent data lines have opposite polarities within the same scanning period and the data signals provided by the same data line have the same polarity within the same frame period.

18. The method according to claim 17, wherein the first sub pixel group and the second pixel group respectively comprise 2m sub pixel units arranged side by side, m being positive integer in a range of 1≦m≦50.
